(19) United States
(12) Patent Application Publication
(10) Pub. No.: US 2018/0209478 A1
(43) Pub. Date: Jul. 26, 2018

(54) Switchable bearing bush for a motor vehicle

(71) Applicant: Schaeffler Technologies AG & Co. KG, Herzogenaurach (DE)

(72) Inventors: Hartmut Krehmer, Erlangen (DE); Peter Rumpel, Werneck / Schraudenbach (DE)

(73) Assignee: Schaeffler Technologies AG & Co. KG, Herzogenaurach (DE)

(21) Appl. No.: 15/745,732

(22) PCT Filed: May 17, 2016
(86) PCT No.: PCT/DE2016/200231

§ 371 Date: Jan. 18, 2018

(30) Foreign Application Priority Data
Aug. 13, 2015 (DE) 10 2015 215 423.8

(51) Int. Cl. F16C 27/06; F16F 1/36; F16F 1/387

(52) U.S. Cl. CPC F16C 27/063; F16F 1/387; F16F 1/3615

(57) ABSTRACT

The disclosure relates to a bearing bushing for a motor vehicle. In one example, the bearing bushing has an inner ring and an outer ring and an elastomer element arranged rotationally fixedly radially between the inner ring and the outer ring. The bearing bushing is switchable between at least two stiffness stages.

The change in stiffness of the bearing bushing may be provided by at least one auxiliary element disposed radially between the inner ring and the outer ring.

### CROSS-REFERENCE TO RELATED APPLICATIONS

This application is the U.S. National Phase of PCT Appln. No. PCT/DE2016/200231 filed May 17, 2016, which claims priority to DE 102015215423.8 filed Aug. 13, 2015, the entire disclosures of which are incorporated by reference herein.

### TECHNICAL FIELD

The disclosure relates to a bearing bushing for a motor vehicle, for example, including an inner ring and an outer ring and an elastomer element arranged rotationally fixedly radially between the inner ring and the outer ring, wherein the bearing bushing is switchable between at least two stiffness stages.

### BACKGROUND

The structure and the resulting operational data of bearing bushings that are used in a chassis of a motor vehicle may have a great influence on the driving and steering characteristics of the motor vehicle. Relatively minor changes to a spring constant or stiffness of the bearing bushings can have considerable effects on the vehicle characteristics, such as for example the understeer or oversteer characteristics and chassis noises, vibrations and running harshness. Depending on the setting of the bearing bushing, the motor vehicle has a relatively “soft” or relatively “hard” running characteristic.

The generally known prior art has disclosed various bearing bushings in the chassis region of a motor vehicle. Firstly, purely mechanical bearing bushings or rubber bearings are known which have a defined stiffness. Furthermore, hydraulically damped chassis bushings with fixed or variable stiffness are known. Furthermore, bearings with magnetorheological liquids or magnetorheological elastomers are known, wherein the stiffness can be varied by a magnetic field.

For example, DE 696 22 141 T2 discloses a method for producing and using a suspension bushing with variable stiffness for controlling the relative movement between a suspension link in a motor vehicle and a frame component of the motor vehicle. The suspension bushing has a variable stiffness, which is realized by virtue of the fact that there is an enclosed magnetorheological elastomer or gel, the stiffness of which is variably adjustable over a wide range, specifically by a controllable magnetic field. The variable controllable magnetic field is generated by an electromagnetic structure which is completely integrated, as part of the structure, into a suspension bushing structure.

### SUMMARY

One problem addressed by the disclosure includes providing a bearing bushing for a motor vehicle, the stiffness of which bearing bushing is mechanically adjustable and is thus not based on a hydraulic or magnetorheological operating principle.

According to the disclosure, for the change in stiffness of the bearing bushing, at least one auxiliary element is provided radially between the inner ring and the outer ring. The at least one auxiliary element may be provided for stiffening the elastomer element. In particular, the elastomer element has a relatively low stiffness, wherein the stiffness of the elastomer element is increased through activation of the at least one auxiliary element. Furthermore, the at least one auxiliary element may be arranged so as to be incorporated into the force flow between the inner ring and the outer ring. This has the effect that introduced force is distributed between the elastomer element and the at least one auxiliary element. The bearing bushing is thereby stiffened. In a first switching position, the force flows only through the elastomer element. By contrast, in a second switching position, the force is conducted via the elastomer element and the at least one auxiliary element. The at least one auxiliary element preferably has a higher stiffness than the elastomer element in order to realize a broad stiffness spread.

It may be preferable for two auxiliary elements to be provided for the change in stiffness of the bearing bushing, wherein the two auxiliary elements come to bear against the elastomer element in each case at an end side. Consequently, the elastomer element is stiffened substantially radially by the two auxiliary elements, wherein the elastomer element is arranged axially between the two auxiliary elements.

In one embodiment, the at least one auxiliary element is formed as an elastomer ring, wherein, for the change in stiffness of the bearing bushing, the elastomer ring is movable axially on the inner ring. Consequently, the increase in stiffness of the bearing bushing is realized by an axial displacement of the respective elastomer ring relative to the elastomer element. The elastomer ring preferably comes to bear radially between the inner ring and the outer ring. In other words, for the increase in stiffness of the bearing bushing, the elastomer ring is placed in engagement radially between the inner ring and the outer ring, such that the elastomer ring and the elastomer element are situated in the force flow of the bearing bushing.

In particular, axially running grooves may be provided at least on an outer circumferential surface of the inner ring and/or on an inner circumferential surface of the outer ring, which grooves interact, for the axial movement of the at least one auxiliary element, with axially running protuberances. Furthermore, a friction-minimizing coating is arranged at least on an outer circumferential surface of the inner ring and/or on an inner circumferential surface of the outer ring.

In a further embodiment, the at least one auxiliary element is formed as a non-elastic ring, wherein, for the change in stiffness of the bearing bushing, the non-elastic ring is movable axially on the inner ring. The non-elastic ring may be composed of a metal or of a rigid polymer material. The non-elastic ring preferably comes to bear radially between the inner ring and the elastomer element. In particular, the non-elastic ring is of wedge-shaped form.

In a further embodiment, the at least one auxiliary element is formed as a support ring, wherein the support ring is arranged on the elastomer element at an end side and, for the change in stiffness of the bearing bushing, is mounted rotatably on the inner ring. A plain bearing bushing or a rolling bearing is preferably formed radially between the inner ring and the support ring. In particular, the support ring is of oval form, such that the contact area of the support ring against the outer ring is relatively small. By contrast, the support ring circumferentially surrounds the inner ring. For the stiffening of the bearing bushing, the support ring is rotated until it is situated parallel to the force flow of the force introduced into the bearing bushing. Consequently, direction-dependent stiffening of the bearing bushing is realized by the support ring.

According to another embodiment, the elastomer element has, at least on one end side, at least one axially formed recess, wherein the at least one auxiliary element is formed as a ring element and has an axially formed protuberance in a manner complementary to the at least one axially formed recess, wherein, for the change in stiffness of the bearing bushing, the ring element is axially movable on the inner ring. Consequently, the at least one axially formed protuberance of the ring element engages axially into the at least one axially formed recess on the elastomer element in order to increase the stiffness of the bearing bushing. In particular, the ring element is likewise formed from an elastomer material. In the case of an axial movement of the ring element relative to the elastomer element, a metal strip or a friction-minimizing coating is arranged between the at least one axially formed protuberance of the ring element and the at least one axially formed recess on the elastomer element.

In a further embodiment, the at least one auxiliary element is a hose arranged within the elastomer element, wherein, for the change in stiffness of the bearing bushing, the hose can be filled with a fluid. In particular, the hose is formed from fiber-reinforced material, whereby an inflation of the hose is prevented. The fluid is preferably a compressible gas, in particular compressed air, wherein an increase in pressure in the hose is associated with an increase in stiffness of the bearing bushing.

The disclosure encompasses the technical teaching whereby, for the change in stiffness of the bearing bushing, at least one actuator, comprising an electric motor or a compressor, is provided, wherein the at least one actuator is connected at least indirectly to the at least one auxiliary element. In particular, the compressor of the actuator is connected via a fluid-conducting line to the hose arranged within the elastomer element. By contrast, the electric motor is preferably connected via a shaft or a linkage to the at least one auxiliary element. The actuator is controllable and regulable automatically by the vehicle system by a control element or manually by a driver of the vehicle.

### BRIEF DESCRIPTION OF THE DRAWINGS

Further measures which improve the disclosure will be presented in more detail below together with the description of additional embodiments of the disclosure on the basis of the figures. In the figures:

FIG. 1 shows a perspective illustration of a chassis link for a motor vehicle, wherein the chassis link has a bearing bushing according to the disclosure,

FIG. 2 shows a schematic sectional illustration for illustrating the structure of the bearing bushing according to the disclosure as per a first embodiment,

FIG. 3 shows a schematic sectional illustration for illustrating the structure of the bearing bushing according to the disclosure as per a second embodiment,

FIG. 4a shows a schematic side view of the bearing bushing according to the disclosure as per a third embodiment,

FIG. 4b shows a schematic sectional illustration for illustrating the structure of the bearing bushing according to the disclosure as per FIG. 4a,

FIG. 5 shows a schematic sectional illustration for illustrating the structure of the bearing bushing according to the disclosure as per a fourth embodiment, and

FIG. 6 shows a schematic sectional illustration for illustrating the structure of the bearing bushing according to the disclosure as per a fifth embodiment.

### DETAILED DESCRIPTION

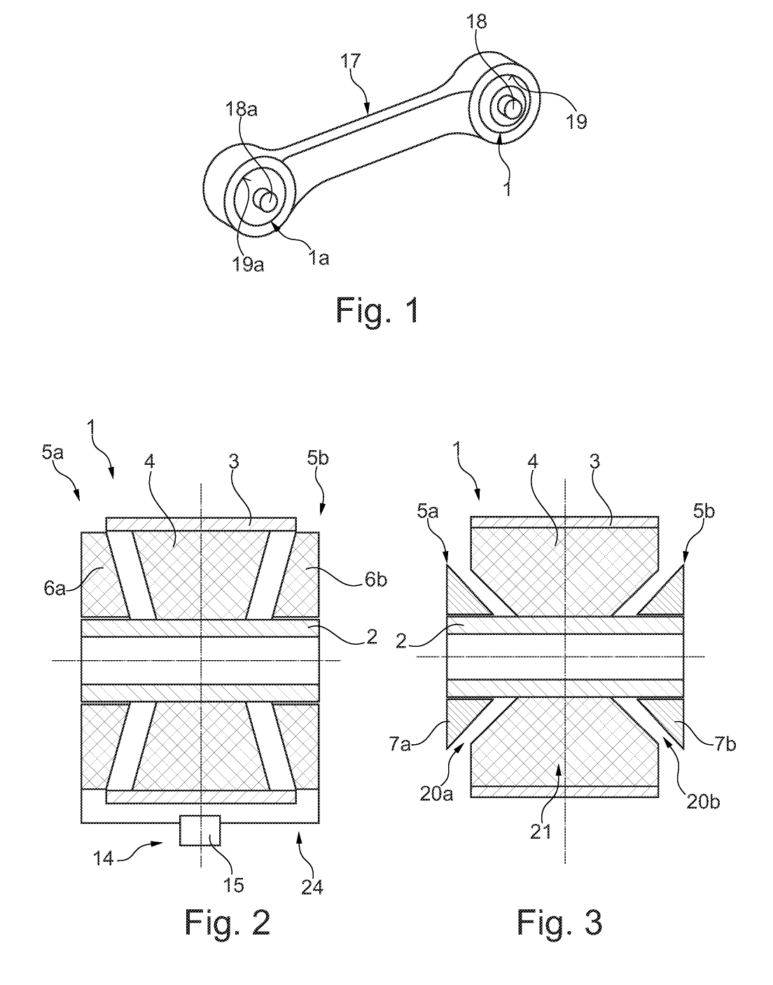

In FIG. 1, a bearing bushing 1 according to the disclosure is arranged in a bore 19, provided for the purpose, on a chassis link 17. The chassis link 17 is installed in a chassis (not illustrated here) of a motor vehicle (not illustrated here). An axle support (not illustrated here) of the motor vehicle is fastened to a bolt 18 of the bearing bushing 1. Furthermore, the chassis link 17 has a further bore 19a in which there is arranged a mechanical, non-switchable bearing bushing 1a. In other words, the bearing bushing 1a is designed as a conventional rubber bearing. A wheel support (not illustrated here) is arranged on a bolt 18a of the bearing bushing 1a.

As per FIGS. 2 to 6, the bearing bushing 1 according to the disclosure comprises an inner ring 2 and an outer ring 3 and an elastomer element 4 arranged radially between, and rotationally fixedly on, the inner ring 2 and the outer ring 3. Furthermore, for the change in stiffness of the bearing bushing 1, at least one auxiliary element 5a, 5b is provided radially between the inner ring 2 and the outer ring 3.

As per FIG. 2, two auxiliary elements 5a, 5b are provided for the change in stiffness of the bearing bushing 1, wherein the two auxiliary elements 5a, 5b come to bear against the elastomer element 4 in each case at an end side. Here, the two auxiliary elements 5a, 5b are formed as a respective elastomer ring 6a, 6b. Furthermore, for the change in stiffness of the bearing bushing 1, the elastomer rings 6a, 6b are axially movable on the inner ring 2, wherein an actuator 14, comprising an electric motor 15, is provided for the axial displacement of the two elastomer rings 6a, 6b. Here, the electric motor is connected via a linkage 24 to the respective elastomer ring 6a, 6b. To increase the stiffness of the bearing bushing 1, the two elastomer rings 6a, 6b come to bear radially between the inner ring 2 and the outer ring 3.

As per FIG. 3, two auxiliary elements 5a, 5b are provided for the change in stiffness of the bearing bushing 1, wherein the two auxiliary elements 5a, 5b come to bear against the elastomer element 4 in each case at an end side. Furthermore, the two auxiliary elements 5a, 5b are each formed as a non-elastic ring 7a, 7b. For the change in stiffness of the bearing bushing 1, the two non-elastic rings 7a, 7b are movable axially on the inner ring 2 and, in order to increase the stiffness of the bearing bushing 1, come to bear radially between the inner ring 2 and the elastomer element 4. The non-elastic rings 7a, 7b are formed from a metallic material. Furthermore, the elastomer element 4 has a respective recess 20a, 20b which is of complementary form with respect to the respective non-elastic ring 7a, 7b. As a result, the elastomer element 4 is of substantially arrow-shaped form toward the inner ring 2, such that a progressive damping characteristic curve of the bearing bushing 1 is realized. This is because, with increasing deformation of the elastomer element 4, the contact area of the elastomer element 4 against the inner ring 2 increases. A major part of the deformation takes place in said arrow-shaped region 21 of the elastomer element 4. Therefore, the non-elastic rings 7a, 7b are used to support the arrow-shaped region 21 in order to increase the stiffness of the bearing bushing 1.

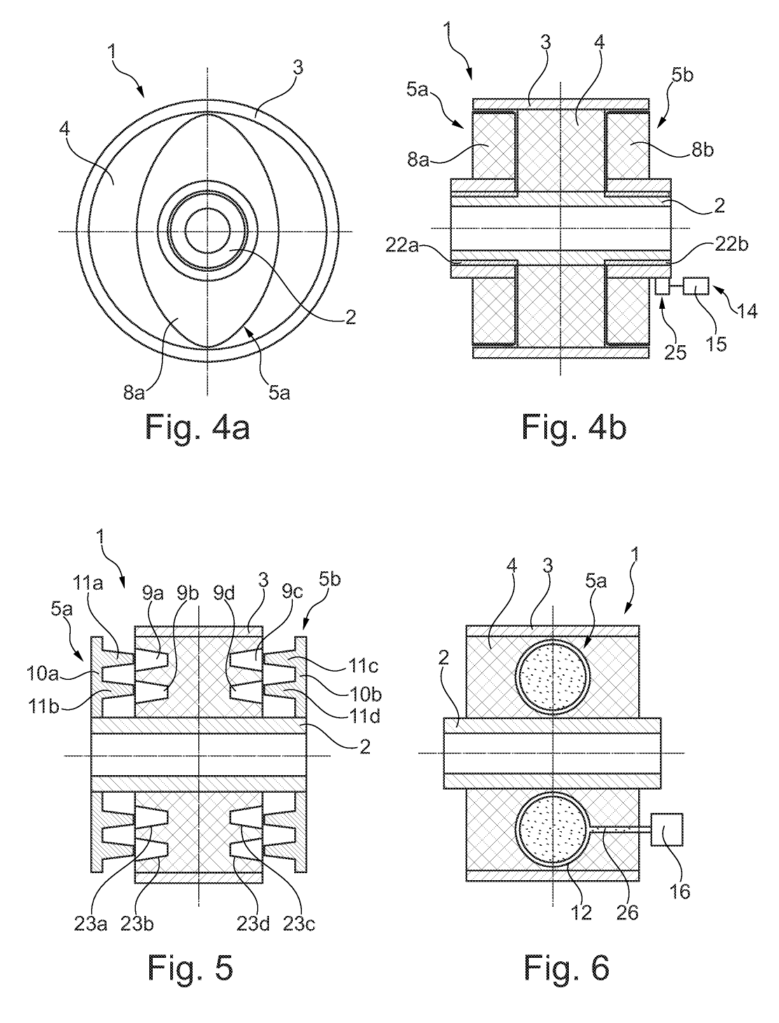

As per FIGS. 4a, 4b, two auxiliary elements 5a, 5b are provided for the change in stiffness of the bearing bushing 1, wherein the two auxiliary elements 5a, 5b come to bear against the elastomer element 4 in each case at an end side. Furthermore, the respective auxiliary element 5a, 5b is formed as a support ring 8a, 8b. For the change in stiffness of the bearing bushing 1, the two support rings 8a, 8b are mounted on the inner ring 2 so as to be rotatable by the actuator 14. For this purpose, a plain bearing bushing 22a, 22b is arranged radially between the respective support ring 8a, 8b and the inner ring 2, wherein the actuator 14 has an electric motor 15 which drives the support ring 8b via a pinion shaft 25. The two support rings 8a, 8b are connected rotationally fixedly to one another. Consequently, direction-dependent stiffening of the bearing bushing 1 is realized by the respective support ring 8a, 8b.

As per FIG. 5, two auxiliary elements 5a, 5b are provided, wherein, for the change in stiffness of the bearing bushing 1, the two auxiliary elements 5a, 5b come to bear against the elastomer element 4 in each case at an end side. Furthermore, on each end side, the elastomer element 4 has in each case two axially formed recesses 9a-9d. The two auxiliary elements 5a, 5b are formed as a respective ring element 10a, 10b. The respective ring element 10a, 10b has axially formed protuberances 11a-11d in a manner complementary to the axially formed recesses 9a-9d. For the change in stiffness of the bearing bushing 1, the two ring elements 10a, 10b are axially movable on the inner ring 2. Furthermore, the respective recesses 9a-9d have a respective metal strip 23a-23d for minimizing friction between the elastomer element 4 and the respective ring element 10a, 10b. In particular, the respective recesses 9a-9d are formed in a ring-shaped manner on the respective end face. In a first switching position (illustrated here), the respective ring element 10a, 10b is axially spaced apart from the elastomer element 4, wherein the respective recess 9a-9d is provided as a weakening structure on the elastomer element 4. Consequently, in this switching position, the stiffness of the bearing bushing 1 is at a minimum. An axial displacement of the two ring elements 10a, 10b toward the elastomer element 4 results in the axially formed protuberances 11a-11d engaging into the axially formed recesses 9a-9d, and thus in stiffening of the bearing bushing 1. Consequently, in a second switching position, the stiffness of the bearing bushing 1 is at a maximum.

As per FIG. 6, the auxiliary element 5a is a hose 12 arranged within the elastomer element 4. Here, the hose 12 is formed from a fiber-reinforced material and interacts, for the change in stiffness of the bearing bushing 1, with a fluid 13 situated therein. The fluid 13 is preferably compressed air, wherein the stiffness of the bearing bushing 1 is dependent on the air pressure in the hose 12. For the change in stiffness of the bearing bushing 1, the hose 12 is connected to an actuator 14. The actuator 14 comprises a compressor 16 which is connected via a fluid-conducting line 26 to the hose 12 for the purposes of increasing the compressed air.

### LIST OF REFERENCE DESIGNATIONS

1, 1a Bearing bushing

2 Inner ring

3 Outer ring

4 Elastomer element

5a, 5b Auxiliary element

6a, 6b Elastomer ring

7a, 7b Non-elastic ring

8a, 8b Support ring

9a-9d Recess

10a, 10b Ring element

11a-11d Protuberance

12 Hose

13 Fluid

14 Actuator

15 Electric motor

16 Compressor

17 Chassis link

18, 18a Bolt

19, 19a Bore

20a, 20b Recess

21 Arrow-shaped region

22a, 22b Plain bearing bushing

23a-23d Metal strip

24 Linkage

25 Pinion shaft

26 Fluid-conducting line

1. A bearing bushing for a motor vehicle, comprising:
an inner ring and an outer ring and an elastomer element arranged rotationally fixedly radially between the inner ring and the outer ring;
wherein the bearing bushing is switchable between at least two stiffness stages, and a change in stiffness of the bearing bushing is configured to be provided by at least one auxiliary element disposed radially between the inner ring and the outer ring.

2. The bearing bushing as claimed in claim 1, wherein the at least one auxiliary element is formed as an elastomer ring, wherein, for the change in stiffness of the bearing bushing, the elastomer ring is movable axially on the inner ring.

3. The bearing bushing as claimed in claim 2, wherein the elastomer ring comes to bear radially between the inner ring and the outer ring.

4. The bearing bushing as claimed in claim 1, wherein the at least one auxiliary element is formed as a non-elastic ring, wherein, for the change in stiffness of the bearing bushing, the non-elastic ring is movable axially on the inner ring.

5. The bearing bushing as claimed in claim 4, wherein the non-elastic ring comes to bear radially between the inner ring and the elastomer element.

6. The bearing bushing as claimed in claim 1, wherein the at least one auxiliary element is formed as a support ring, wherein the support ring is arranged on the elastomer element at an end side and, for the change in stiffness of the bearing bushing, is mounted rotatably on the inner ring.

7. The bearing bushing as claimed in claim 1, wherein the elastomer element has, at least on one end side, at least one axially formed recess, wherein the at least one auxiliary element is formed as a ring element and has an axially formed protuberance in a manner complementary to the at least one axially formed recess, wherein, for the change in stiffness of the bearing bushing, the ring element is axially movable on the inner ring.

8. The bearing bushing as claimed in claim 1, wherein two auxiliary elements are provided for the change in stiffness of the bearing bushing, wherein, for the change in stiffness of the bearing bushing, the two auxiliary elements come to bear against the elastomer element in each case at an end side.

9. The bearing bushing as claimed in claim 1, wherein the at least one auxiliary element is a hose arranged within the elastomer element, wherein, for the change in stiffness of the bearing bushing, the hose is configured to be filled with a fluid.

10. The bearing bushing as claimed in claim 1, wherein for the change in stiffness of the bearing bushing, at least one actuator, comprising an electric motor or a compressor, is provided, wherein the at least one actuator is connected at least indirectly to the at least one auxiliary element.

11. A method of switching a stiffness of a bearing bushing, comprising:
providing a bushing bearing including an inner ring, an outer ring, an elastomer element arranged radially between the inner ring and the outer ring, and an auxiliary element arranged radially between the inner ring and the outer ring; and
changing the stiffness of the bearing bushing from a first stiffness to a second stiffness by moving the auxiliary element axially on the inner ring.

12. The method of claim 11, wherein the auxiliary element is formed as an elastomer ring, wherein, for the change in stiffness of the bearing bushing, the elastomer ring is moved axially on the inner ring.

13. The method of claim 12, wherein the elastomer ring comes to bear radially between the inner ring and the outer ring.

14. The method of claim 11, wherein the auxiliary element is formed as a non-elastic ring, wherein, for the change in stiffness of the bearing bushing, the non-elastic ring is moved axially on the inner ring.

15. The method of claim 14, wherein the non-elastic ring comes to bear radially between the inner ring and the elastomer element.

16. The method of claim 11, wherein the elastomer element has, at least on one end side, an axially formed recess, wherein the auxiliary element is formed as a ring element and has an axially formed protuberance in a manner complementary to the axially formed recess, wherein, for the change in stiffness of the bearing bushing, the ring element is axially moved on the inner ring.

17. The method of claim 11, wherein for the change in stiffness of the bearing bushing, an actuator including an electric motor or a compressor is provided; and
the actuator is connected at least indirectly to the auxiliary element and is configured to move the auxiliary element axially on the inner ring.
